(19) United States
(12) Patent Application Publication
(10) Pub. No.: US 2020/0106711 A1
(43) Pub. Date: Apr. 2, 2020

(54) APPARATUS AND METHOD FOR MANAGING APPLICATION ON MULTI-CLOUD SERVICE ENVIRONMENT

(71) Applicant: ELECTRONICS AND TELECOMMUNICATIONS RESEARCH INSTITUTE, Daejeon (KR)

(72) Inventors: Song-Woo SOK, Daejeon (KR); Ganis Zulfa Santoso, Daejeon (KR); Young-Woo JUNG, Daejeon (KR)

(21) Appl. No.: 16/583,538

(22) Filed: Sep. 26, 2019

(30) Foreign Application Priority Data
Oct. 2, 2018 (KR) 10-2018-0117640

(51) Int. Cl. H04L 12/911; H04L 29/08; H04L 12/24; G06F 8/61

(52) U.S. Cl. CPC H04L 47/70; G06F 8/61; H04L 41/12; H04L 67/10

(57) ABSTRACT

An apparatus and method for managing an application. The apparatus for managing an application includes a reception unit for receiving an instruction to deploy the application from an application service provider, a deployment plan generation unit for generating application deployment plan information based on application topology corresponding to the application, a resource management unit for allocating a cloud resource based on the application deployment plan information, an application installation unit for installing the application in the allocated cloud resource and setting up the application, and an application execution unit for running the application.

### CROSS REFERENCE TO RELATED APPLICATION

This application claims the benefit of Korean Patent Application No. 10-2018-0117640, filed Oct. 2, 2018, which is hereby incorporated by reference in its entirety into this application.

### BACKGROUND OF THE INVENTION

### 1. Technical Field

The present invention relates generally to application management technology, and more particularly to technology for automatically managing the life cycle of an application on multi-cloud computing infrastructure.

### 2. Description of Related Art

These days, server-side applications for providing applications to mobile users are implemented using cloud infrastructure and provide the services thereof through the cloud infrastructure. A cloud service, which means a model in which a user is freely assigned a desired resource, uses the assigned resource, and pays for the use of the resource, is easy to use and manage, and thus the number of users thereof is increasing.

However, according to the conventional art, a server application based on an IaaS cloud service is installed and managed by those who provide the application, and it is difficult to automate the deployment of the application. Also, when the deployment of a server application is changed as needed in a multi-cloud environment, the deployment must be changed manually.

Therefore, it is necessary to develop technology for automating the deployment and management of a server application based on an IaaS cloud service in order to improve the convenience of cloud service users.

### DOCUMENTS OF RELATED ART

(Patent Document 1) Korean Patent Application Publication No. 10-2015-0137530, published on Dec. 9, 2015 and titled “System and method for managing multi-cloud deployment”
(Patent Document 2) Korean Patent No. 10-1544359, published on Aug. 13, 2015 and titled “System and method for describing applications for manageability and efficient scale-up deployment”.

### SUMMARY OF THE INVENTION

An object of the present invention is to improve the convenience of cloud service users by automating the deployment and management of a server application based on an IaaS cloud service.

Another object of the present invention is to enable the process of deploying, stopping, and redeploying an application to be simply performed by registering information about the application only once.

A further object of the present invention is to deploy and manage an application by selecting a cloud service provider that best meets the requirements of the application, among multiple cloud service providers.

In order to accomplish the above objects, an apparatus for managing an application according to the present invention includes a reception unit for receiving an instruction to deploy the application from an application service provider; a deployment plan generation unit for generating application deployment plan information based on application topology corresponding to the application; a resource management unit for allocating a cloud resource based on the application deployment plan information; an application installation unit for installing the application in the allocated cloud resource and setting up the application; and an application execution unit for running the application.

Here, the application topology may be stored in an application repository by the application service provider.

Here, the application repository may store at least one of the application topology corresponding to the application, an application installation file, the application deployment plan information, and application deployment state information.

Here, the application installation unit may install the application in the cloud resource using at least one of the application installation file and an installation script, which are stored by the application service provider, and set up the application.

Here, the apparatus may further include a storage unit for storing the application deployment state information in the application repository after running the application.

Here, the application execution unit may perform an application stop process based on the application topology when an instruction to stop the application is received from the application service provider.

Here, the apparatus may further include a deployment state management unit for updating the application deployment state information when the cloud resource is deallocated by performing the application stop process.

Here, the resource management unit may select a target cloud service provider from among multiple cloud service providers based on the application deployment plan information and allocate the cloud resource of the target cloud service provider.

Here, the application topology may include at least one of requirements for installing the application, information about components of the application, information about relationships between the components of the application, information about a process required for installation of the application, and information about files required for the installation of the application.

Here, the deployment plan generation unit may generate the application deployment plan information based on the application topology and the cloud resource provided by the cloud service provider.

Also, a method for managing an application, performed by an apparatus for managing the application, according to an embodiment of the present invention includes receiving an instruction to deploy the application from an application service provider; generating application deployment plan information based on application topology corresponding to the application; allocating a cloud resource based on the application deployment plan information; installing the application in the allocated cloud resource and setting up the application; and running the application.

Here, the application topology may be stored in an application repository by the application service provider.

Here, the application repository may store at least one of the application topology corresponding to the application, an application installation file, the application deployment plan information, and application deployment state information.

Here, installing the application in the allocated cloud resource and setting up the application may be configured to install the application in the cloud resource using at least one of the application installation file and an installation script, which are stored by the application service provider, and to set up the application.

Here, the method may further include storing the application deployment state information in the application repository after running the application.

Here, the method may further include receiving an instruction to stop the application from the application service provider and performing an application stop process based on the application topology.

Here, performing the application stop process may include deallocating the cloud resource; and updating the application deployment state information.

Here, allocating the cloud resource may be configured to select a target cloud service provider from among multiple cloud service providers based on the application deployment plan information and to allocate the cloud resource of the target cloud service provider.

Here, the application topology may include at least one of requirements for installing the application, information about components of the application, information about relationships between the components of the application, information about a process required for installation of the application, and information about files required for the installation of the application.

Here, generating the application deployment plan information may be configured to generate the application deployment plan information based on the application topology and the cloud resource provided by the cloud service provider.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view that schematically shows an environment in which an apparatus for managing an application according to an embodiment of the present invention is applied;

FIG. 2 is a block diagram that shows the configuration of an apparatus for managing an application according to an embodiment of the present invention;

FIG. 3 is a view that shows a target that is stored in an application repository according to an embodiment of the present invention;

FIG. 4 is a flowchart for explaining a method for managing an application when an instruction to deploy the application is input according to an embodiment of the present invention;

FIG. 5 is a flowchart for explaining a method for managing an application when an instruction to stop the application is input according to an embodiment of the present invention;

FIG. 6 is a flowchart for explaining the process of storing information in an application repository according to an embodiment of the present invention; and

FIG. 7 is a block diagram that shows a computer system according to an embodiment of the present invention.

### DESCRIPTION OF THE PREFERRED EMBODIMENTS

Because the present invention may be variously changed and may have various embodiments, specific embodiments will be described in detail below with reference to the attached drawings.

However, it should be understood that those embodiments are not intended to limit the present invention to specific disclosure forms and that they include all changes, equivalents or modifications included in the spirit and scope of the present invention.

The terms used in the present specification are merely used to describe specific embodiments, and are not intended to limit the present invention. A singular expression includes a plural expression unless a description to the contrary is specifically pointed out in context. In the present specification, it should be understood that terms such as “include” or “have” are merely intended to indicate that features, numbers, steps, operations, components, parts, or combinations thereof are present, and are not intended to exclude the possibility that one or more other features, numbers, steps, operations, components, parts, or combinations thereof will be present or added.

Unless differently defined, all terms used here, including technical or scientific terms, have the same meanings as terms generally understood by those skilled in the art to which the present invention pertains. Terms identical to those defined in generally used dictionaries should be interpreted as having meanings identical to contextual meanings of the related art, and are not to be interpreted as having ideal or excessively formal meanings unless they are definitively defined in the present specification.

Hereinafter, a preferred embodiment of the present invention will be described in detail with reference to the accompanying drawings. In the following description of the present invention, the same reference numerals are used to designate the same or similar elements throughout the drawings, and repeated descriptions of the same components will be omitted.

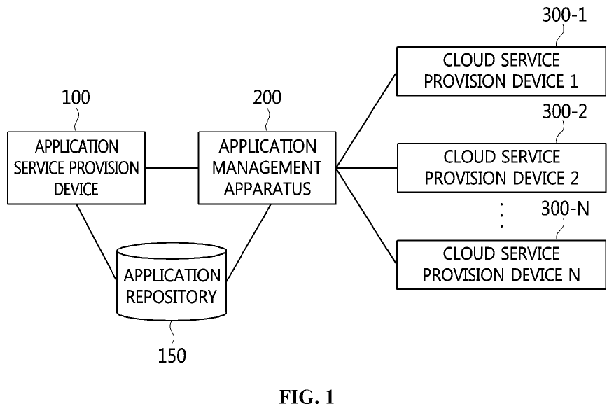

FIG. 1 is a view that schematically shows an environment in which an apparatus for managing an application according to an embodiment of the present invention is applied.

As shown in FIG. 1, an application management system on multi-cloud computing infrastructure includes one or more application service provision devices 100, an application repository 150, an application management apparatus 200, and multiple cloud service provision devices 300.

First, the application service provision device 100 may correspond to an application service provider intending to run a server application using an IaaS cloud service.

The application service provision device 100 may store information and files required for the installation of an application in the application repository 150 in advance. Here, the application service provision device 100 may store at least one of application topology and an application installation file in the application repository 150.

Also, the application service provision device 100 may transmit at least one of an application deployment instruction and an application stop instruction to the application management apparatus 200.

The application repository 150 may store at least one of application topology and an application installation file registered by the application service provision device 100.

Also, the application repository 150 may receive application deployment plan information and application state information from the application management apparatus 200 and store the same therein.

The application management apparatus 200 supports the installation, migration, deletion, and the like of an application on multi-cloud computing infrastructure and manages an application life cycle.

Also, in order to enable the application service provision device 100 to run a server application using an IaaS cloud service, the application management apparatus 200 may be provided with information and files required for the installation of the application.

Also, in response to a user request, such as an application deployment instruction or the like, the application management apparatus 200 selects a cloud service that is suitable for the application based on the information and files provided in advance, thereby automatically deploying and managing the application.

The application management apparatus 200 may receive at least one of an application deployment instruction and an application stop instruction from the application service provision device 100, and may transmit at least one of application deployment plan information and application state information to the application repository 150 so as to be stored therein.

Particularly, in response to an application deployment instruction, the application management apparatus 200 establishes an application deployment plan and transmits information thereabout to the application repository 150 so as to be stored therein.

Also, after it generates or modifies application state information, the application management apparatus 200 may transmit the application state information to the application repository 150 so as to be stored therein.

The cloud service provision device 300 is a cloud service provider for providing a cloud service.

At least some of the multiple cloud service provision devices 300 may be public cloud service provision devices, and the application management apparatus 200 according to an embodiment of the present invention may include an adapter module for overcoming the difference between the cloud service provision devices 300. Because the application management apparatus 200 includes such an adapter module therein, the cloud service provision devices 300 may be implemented without any special module or special manipulation.

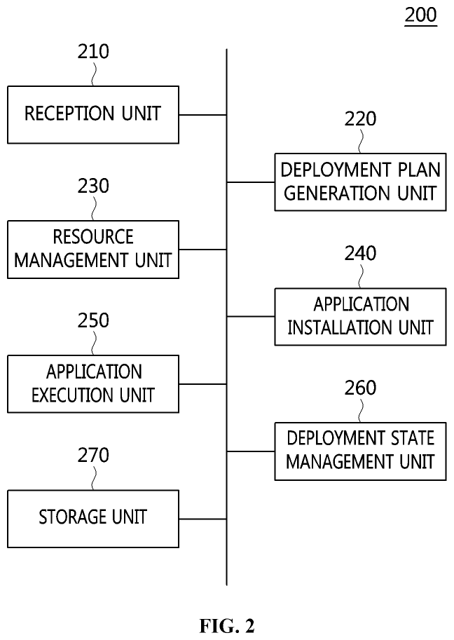

Hereinafter, the configuration of an apparatus for managing an application according to an embodiment of the present invention will be described in detail with reference to FIG. 2.

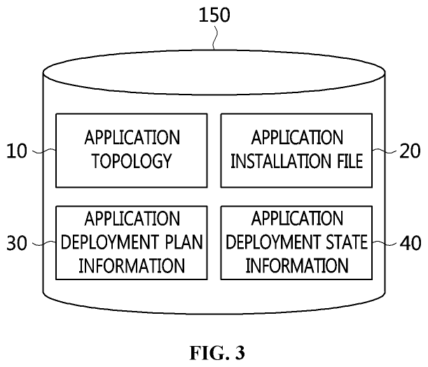

FIG. 2 is a block diagram that shows the configuration of an apparatus for managing an application according to an embodiment of the present invention, and FIG. 3 is a view that shows a target that is stored in an application repository according to an embodiment of the present invention.

As shown in FIG. 2, the application management apparatus 200 includes a reception unit 210, a deployment plan generation unit 220, a resource management unit 230, an application installation unit 240, an application execution unit 250, a deployment state management unit 260, and a storage unit 270.

Also, as shown in FIG. 3, application topology 10, an application installation file 20, application deployment plan information 30, and application deployment state information 40 may be stored in the application repository 150.

The reception unit 210 illustrated in FIG. 2 may receive an instruction to deploy an application or an instruction to stop an application from the application service provision device 100.

When an instruction to deploy an application is input, the deployment plan generation unit 220 establishes an application deployment plan and generates and stores application deployment plan information 30.

The deployment plan generation unit 220 may generate application deployment plan information 30 based on the application topology 10 pertaining to a corresponding application. Here, the application topology 10 has been stored in the application repository 150 by the application service provision device 100.

Also, the deployment plan generation unit 220 selects a target cloud service provision device, which is a cloud service provision device suitable for the application to be deployed, from among the multiple cloud service provision devices 300 based on the application topology 10 and selects a cloud resource type, thereby generating application deployment plan information 30.

The resource management unit 230 may allocate a cloud resource of the target cloud service provision device based on the application deployment plan information, or may deallocate the resource of a stopped application.

The application installation unit 240 may install an application in the allocated cloud resource and set up the application. Here, the application installation unit 240 may install the application using at least one of an application installation file 20 and an installation script, which are stored in the application repository 150 by the application service provision device 100.

The application execution unit 250 runs the installed application.

Also, when an instruction to stop an application is received from the application service provision device 100, the application execution unit 250 may perform an application stop process based on the application topology.

The deployment state management unit 260 may store an application deployment state and monitoring data as application deployment state information when an application is run. Also, when a cloud resource is deallocated by performing an application stop process, the deployment state management unit 260 may update the application deployment state information.

The storage unit 270 may store the application deployment plan information, which is generated by the deployment plan generation unit 220, in the application repository 150.

Also, when an application is run, the storage unit 270 may store the application deployment state information pertaining to the run application in the application repository 150. Also, when the application deployment state information is updated by performing the application stop process, the storage unit 270 may store the updated application deployment state information in the application repository 150.

Meanwhile, the application topology 10, stored in the application repository 150 as shown in FIG. 3, may include information about requirements for installation of an application, information about the components of the application, information about the relationships between the components of the application, information about an installation process, information about files required for the installation, and the like.

The application installation file 20 may include an installation executable and a bundle of files that are required to be installed in order to actually run an application.

The application deployment plan information 30 may include an application installation plan file, which is generated by mapping the application topology 10 to the cloud resources actually provided by the cloud service provision device 300.

Also, the application deployment state information 40 may include information about applications actually installed in the cloud resource and detailed information about the cloud resource.

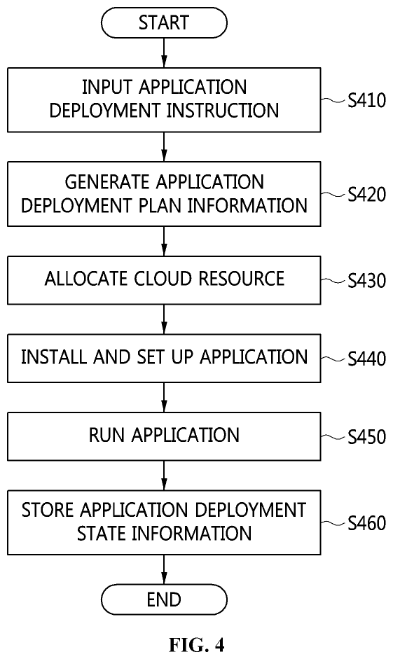

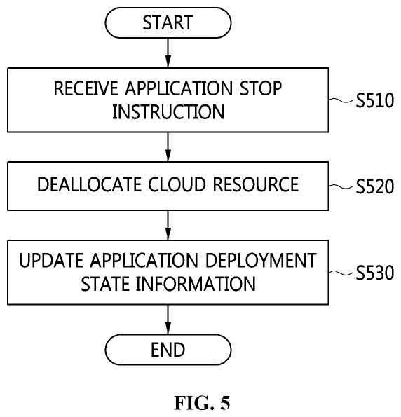

Hereinafter, an application management method performed by an application management apparatus according to an embodiment of the present invention will be described in detail with reference to FIG. 4 and FIG. 5.

FIG. 4 is a flowchart for explaining a method for managing an application when an instruction to deploy the application is input according to an embodiment of the present invention.

First, when it receives an application deployment instruction from the application service provision device 100 at step S410, the application management apparatus 200 generates application deployment plan information at step S420.

The application management apparatus 200 may establish an application deployment plan with reference to the application topology of an application corresponding to the application deployment instruction. Here, the application management apparatus 200 may generate application deployment plan information by selecting a target cloud service provision device and a cloud resource type depending on the application.

Subsequently, the application management apparatus 200 allocates a cloud resource based on the application deployment plan information at step S430.

The application management apparatus 200 installs and sets up the application at step S440 and runs the installed application at step S450.

The application management apparatus 200 installs the application in the allocated cloud resource using an installation script and an application installation file provided by the application service provision device 100, sets up the application, and runs the application.

Finally, the application management apparatus 200 stores application deployment state information at step S460.

The application management apparatus 200 may store information about the deployment state of the application, which is run after being installed, and monitoring data pertaining to the application as the application deployment state information.

FIG. 5 is a flowchart for explaining a method for managing an application when an instruction to stop the application is input according to an embodiment of the present invention.

When it receives an application stop instruction at step S510, the application management apparatus 200 deallocates a cloud resource at step S520.

Based on the application deployment state information, the application management apparatus 200 obtains information about the cloud resource that is being used. Then, the application management apparatus 200 performs an application stop process based on the application topology stored in the application repository 150.

Here, the application stop process is set by the application service provision device 100, and the application management apparatus 200 may perform the application stop process in the cloud resource that is being used, and may then deallocate the corresponding cloud resource when the application stop process is finished.

Subsequently, the application management apparatus 200 updates the application deployment state information at step S530.

After the cloud resource is deallocated, the application management apparatus 200 may update the application deployment state information to a stop state and store the updated application deployment state information.

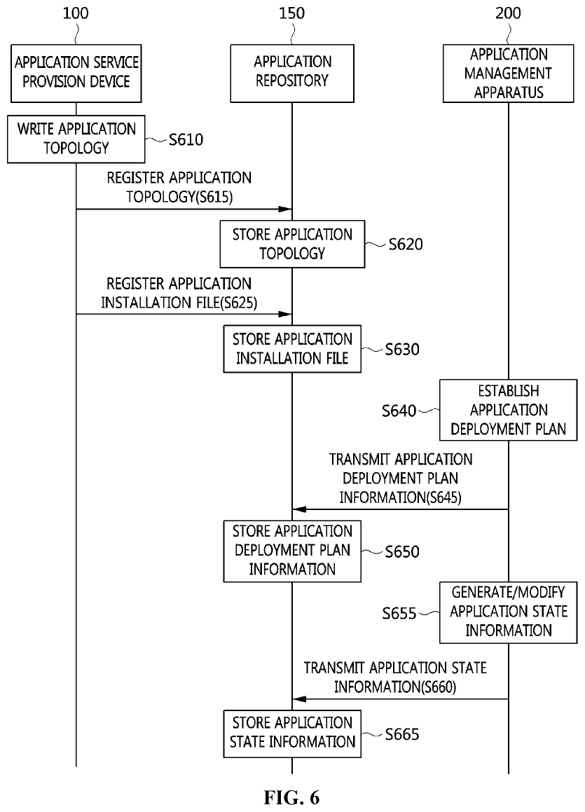

FIG. 6 is a flowchart for explaining a process in which information is stored in an application repository according to an embodiment of the present invention.

The application repository 150 may store application topology and an application installation file registered by the application service provision device 100. Also, the application repository 150 may receive application deployment plan information and application state information from the application management apparatus 200 and store the same.

As shown in FIG. 6, the application service provision device 100 writes application topology at step S610.

The application service provision device 100 may write the application topology in a predefined format so as to include at least one of information about requirements for the installation of an application, information about the components of the application, information about the relationships between the components of the application, information about an application installation process, and information about files required for the installation.

The application service provision device 100 registers the application topology in the application repository 150 at step S615. The application repository 150 stores the application topology at step S620.

Also, the application service provision device 100 registers an application installation file in the application repository 150 at step S625, thereby storing the same in the application repository 150 at step S630.

Here, the application service provision device 100 may register the application installation file, which includes at least one of an installation executable and files that must be installed in order to actually run the application, in the application repository 150.

Also, when it receives an application deployment instruction from the application service provision device 100, the application management apparatus 200 generates application deployment plan information at step S640.

The application management apparatus 200 selects a target cloud service provision device for the application based on the application topology and selects a cloud resource type, thereby generating application deployment plan information including an application installation plan file.

Subsequently, the application management apparatus 200 may transmit the generated application deployment plan information to the application repository 150 at step S645 and store the same in the application repository 150 at step S650.

Also, when application state information is generated or when the application state information is updated at step S655, the application management apparatus 200 may transmit the application state information to the application repository 150 at step S660 and store the same in the application repository 150 at step S665.

Particularly, when application deployment state information is generated as a result of running the application, the application management apparatus 200 may store the generated application deployment state information in the application repository 150. Also, when it deallocates a cloud resource in response to an instruction to stop the application and updates the application deployment state information, the application management apparatus 200 may transmit the application deployment state information to the application repository 150 and store the same in the application repository 150.

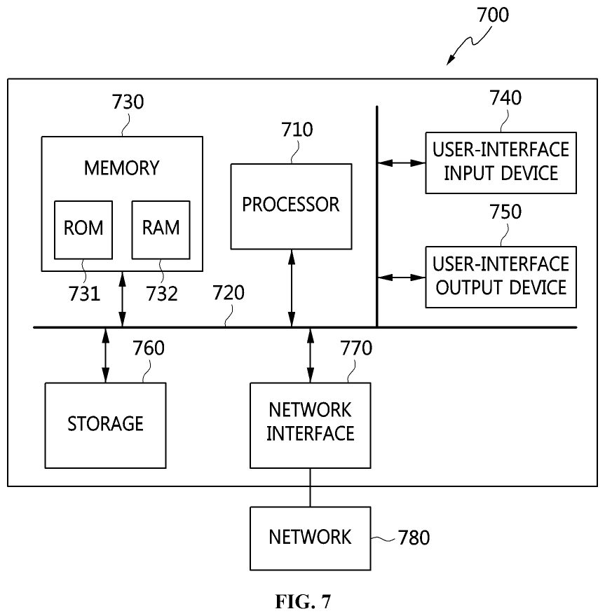

FIG. 7 is a block diagram that shows a computer system according to an embodiment of the present invention.

Referring to FIG. 7, an embodiment of the present invention may be implemented in a computer system 700 including a computer-readable recording medium. As illustrated in FIG. 7, the computer system 700 may include one or more processors 710, memory 730, a user-interface input device 740, a user-interface output device 750, and storage 760, which communicate with each other via a bus 720. Also, the computer system 700 may further include a network interface 770 connected to a network 780. The processor 710 may be a central processing unit or a semiconductor device for executing processing instructions stored in the memory 730 or the storage 760. The memory 730 and the storage 760 may be any of various types of volatile or nonvolatile storage media. For example, the memory may include ROM 731 or RAM 732.

Accordingly, an embodiment of the present invention may be implemented as a nonvolatile computer-readable storage medium in which methods implemented using a computer or instructions executable in a computer are recorded. When the computer-readable instructions are executed by a processor, the computer-readable instructions may perform a method according to at least one aspect of the present invention.

According to the present invention, the convenience of cloud service users may be improved by automating the deployment and management of a server application based on an IaaS cloud service.

Also, according to the present invention, the process of deploying, stopping, and redeploying an application may be simply performed by registering information about the application only once.

Also, according to the present invention, an application may be deployed and managed by selecting the cloud service provider that best meets the requirements of the application, among multiple cloud service providers.

As described above, the apparatus and method for managing an application according to the present invention are not limitedly applied to the configurations and operations of the above-described embodiments, but all or some of the embodiments may be selectively combined and configured, so that the embodiments may be modified in various ways.

What is claimed is:

1. An apparatus for managing an application, comprising:
a reception unit for receiving an instruction to deploy the application from an application service provider;
a deployment plan generation unit for generating application deployment plan information based on application topology corresponding to the application;
a resource management unit for allocating a cloud resource based on the application deployment plan information;
an application installation unit for installing the application in the allocated cloud resource and setting up the application; and
an application execution unit for running the application.

2. The apparatus of claim 1, wherein the application topology is stored in an application repository by the application service provider.

3. The apparatus of claim 2, wherein the application repository stores at least one of the application topology corresponding to the application, an application installation file, the application deployment plan information, and application deployment state information.

4. The apparatus of claim 3, wherein the application installation unit installs the application in the cloud resource using at least one of the application installation file and an installation script, which are stored by the application service provider, and sets up the application.

5. The apparatus of claim 3, further comprising:
a storage unit for storing the application deployment state information in the application repository after running the application.

6. The apparatus of claim 3, wherein the application execution unit performs an application stop process based on the application topology when an instruction to stop the application is received from the application service provider.

7. The apparatus of claim 6, further comprising:
a deployment state management unit for updating the application deployment state information when the cloud resource is deallocated by performing the application stop process.

8. The apparatus of claim 3, wherein the resource management unit selects a target cloud service provider from among multiple cloud service providers based on the application deployment plan information and allocates the cloud resource of the target cloud service provider.

9. The apparatus of claim 3, wherein the application topology includes at least one of requirements for installing the application, information about components of the application, information about relationships between the components of the application, information about a process required for installation of the application, and information about files required for the installation of the application.

10. The apparatus of claim 9, wherein the deployment plan generation unit generates the application deployment plan information based on the application topology and the cloud resource provided by the cloud service provider.

11. A method for managing an application, performed by an apparatus for managing the application, comprising:
receiving an instruction to deploy the application from an application service provider;
generating application deployment plan information based on application topology corresponding to the application;
allocating a cloud resource based on the application deployment plan information;
installing the application in the allocated cloud resource and setting up the application; and
running the application.

12. The method of claim 11, wherein the application topology is stored in an application repository by the application service provider.

13. The method of claim 12, wherein the application repository stores at least one of the application topology corresponding to the application, an application installation file, the application deployment plan information, and application deployment state information.

14. The method of claim 13, wherein installing the application in the allocated cloud resource and setting up the application is configured to install the application in the cloud resource using at least one of the application installation file and an installation script, which are stored by the application service provider, and to set up the application.

15. The method of claim 13, further comprising:
storing the application deployment state information in the application repository after running the application.

16. The method of claim 13, further comprising:
receiving an instruction to stop the application from the application service provider, and
performing an application stop process based on the application topology.

17. The method of claim 16, wherein performing the application stop process comprises:
deallocating the cloud resource; and
updating the application deployment state information.

18. The method of claim 13, wherein allocating the cloud resource is configured to select a target cloud service provider from among multiple cloud service providers based on the application deployment plan information and to allocate the cloud resource of the target cloud service provider.

19. The method of claim 13, wherein the application topology includes at least one of requirements for installing the application, information about components of the application, information about relationships between the components of the application, information about a process required for installation of the application, and information about files required for the installation of the application.

20. The method of claim 19, wherein generating the application deployment plan information is configured to generate the application deployment plan information based on the application topology and the cloud resource provided by the cloud service provider.
